(19) United States
(12) Patent Application Publication
(10) Pub. No.: US 2026/0353454 A1
(43) Pub. Date: Nov. 5, 2026

(54) Communications Systems with Distributed Channel Access Conditioning

(71) Applicant: Apple Inc., Cupertino, CA (US)

(72) Inventors: Mohamed Abouelseoud, Burlingame, CA (US); Ahmad Reza Hedayat, Carlsbad, CA (US)

(21) Appl. No.: 19/646,272

(22) Filed: Apr. 13, 2026

Related U.S. Application Data
(60) Provisional application No. 63/798,394, filed on May 1, 2025.

(51) Int. Cl. H04W 74/0816; H04W 74/08

(52) U.S. Cl. CPC H04W 74/0816; H04W 74/0875

(57) ABSTRACT

A communication system is provided in which access points (APs) communicate with stations (STAs). An AP may associate with Priority Enhanced Distributed Channel Access (P-EDCA) STAs. A STA may attempt to access a channel of the AP using P-EDCA when a condition has been satisfied and may attempt to access the channel using EDCA when the condition has not been satisfied. P-EDCA includes transmission of a defer frame that locks out other STAs from contending for channel access. The defer frame may have a recipient address (RA) field set to a broadcast address or to another address announced by the AP. The condition may be based on an MSDU expiration timer, a priority level, a P-EDCA TXOP limit, a minimum P-EDCA access interval duration, or a maximum defer frame retransmission threshold. The AP may announce one or more of these parameters in an E-PDCA parameter element.

This application claims the benefit of U.S. Provisional Patent Application No. 63/798,394, filed May 1, 2025, which is hereby incorporated by reference herein in its entirety.

### FIELD

This disclosure relates generally to wireless communications, including wireless communications by electronic devices.

### BACKGROUND

Communications systems and methods are used to convey wireless data between nodes of a communications network. The nodes can include user equipment devices, wireless access points, wireless base stations, or other electronic devices.

It can be challenging to ensure that communications systems exhibit sufficient levels of performance. If care is not taken, communication between nodes of a communications network can exhibit excessive latency or can consume excessive resources.

### SUMMARY

A communication system is provided in which access points (APs) communicate with stations (STAs) (e.g., under an 802.11 protocol). An access point may associate with Priority Enhanced Distributed Channel Access (P-EDCA) capable STAs and P-EDCA incapable STAs. A P-EDCA capable STA may determine whether a condition associated with accessing a channel of the AP has been satisfied. The STA may attempt to access the channel using a P-EDCA process when the condition has been satisfied. The STA may attempt to access the channel using an EDCA process when the condition has not been satisfied.

The P-EDCA process may involve transmission of a defer frame. The defer frame may serve to lock out other STAs from contending for channel access for a protected service period. The defer frame may have a recipient address (RA) field set to a broadcast address, another address announced by the AP, a BSSID address, or a reserved address that is agreed on beforehand. The condition used to determine whether to attempt channel access using the P-EDCA process or the EDCA process may include a MAC service data unit (MSDU) expiration timer being below a threshold, the retransmission count for specific access category allowed to use P-EDCA for accessing the channel being above a threshold, queued uplink data having at least a threshold priority level (e.g., having a voice access category (AC)), a transmission opportunity (TXOP) duration being below a P-EDCA TXOP limit (e.g., as announced by the AP), greater than a minimum P-EDCA access interval duration (e.g., as announced by the AP) having elapsed since the last defer frame transmission by the STA, and/or fewer than a maximum defer frame retransmission threshold of defer frame retransmissions (e.g., as announced by the AP) having been performed by the STA. If desired, the AP may announce one or more of these parameters in an E-PDCA parameter element.

### BRIEF DESCRIPTION OF THE DRAWINGS

FIG. 1 is a diagram of an illustrative wireless communications system in accordance with some embodiments.

FIG. 2 is a schematic diagram of an illustrative wireless station (STA) in accordance with some embodiments.

FIG. 3 is a schematic diagram of an illustrative wireless access point (AP) in accordance with some embodiments.

FIG. 4 is a diagram of an illustrative network deployment that includes Priority Enhanced Distributed Channel Access (P-EDCA) capable STAs and P-EDCA incapable STAs that may attempt to access a channel of an AP in accordance with some embodiments.

FIG. 5 is a timing diagram showing one example of how P-EDCA capable STAs and P-EDCA incapable STAs may attempt to access a channel of an AP in accordance with some embodiments.

FIG. 6 is a flow chart of illustrative operations that may be performed by a P-EDCA capable STA to access a channel based on one or more conditions in accordance with some embodiments.

FIG. 7 is a table of illustrative conditions that may be imposed on a P-EDCA capable STA for the STA to access a channel using a P-EDCA procedure in accordance with some embodiments.

FIG. 8 is a diagram of an illustrative P-EDCA parameter element that may be transmitted by an AP in accordance with some embodiments.

### DETAILED DESCRIPTION

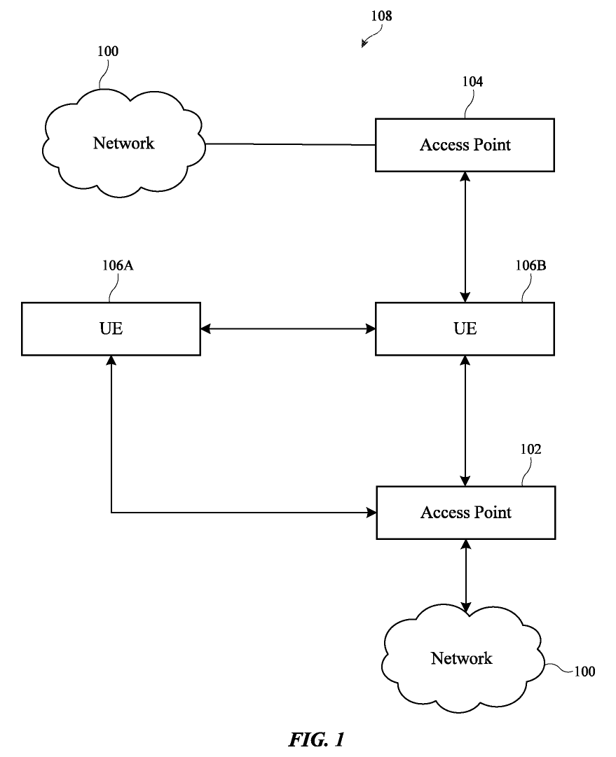

FIG. 1 illustrates an example of a wireless communication system 108 (sometimes also referred to herein as wireless communications network 108, communications network 108, network 108, or system 108). It is noted that FIG. 1 represents one possibility among many, and that features of the present disclosure may be implemented in any of various systems, as desired. For example, embodiments described herein may be implemented in any type of wireless device. The wireless embodiment described below is one example embodiment.

As shown in FIG. 1, the exemplary wireless communication system 108 includes an access point (AP) 104, which communicates over a transmission medium with one or more wireless devices 106 (e.g., a first wireless device 106A, a second wireless device 106B, etc.). Wireless devices 106A and 106B may be user devices (e.g., user equipment (UE) devices), such as stations (STAs), non-AP STAs, or wireless local area network (WLAN) devices. Wireless devices 106 are sometimes referred to herein as STAs 106, clients 106, or non-AP STAs 106.

STA 106 may be a device with wireless network connectivity such as a mobile (e.g., cellular) telephone, a hand-held device, a wearable device (e.g., a wristwatch device, pendant device, ring device, head-mounted device such as a virtual, mixed, and/or augmented reality headset, goggles, helmet, or glasses, etc.), a computer (e.g., a desktop computer, laptop computer, a computer monitor containing an embedded computer, etc.), a tablet computer, a media player, headphones, one or two wireless earbuds, a television, a gaming device or console, a navigation device, an embedded system such as a system in which electronic equipment with a display is mounted in a kiosk or automobile, a wireless internet-connected voice-controlled speaker, a home entertainment device, a remote control device, a gaming controller, a user input device, peripheral, or accessory, an electronic stylus or pen, an unmanned aerial vehicle (UAV), an unmanned aerial controller (UAC), an automobile, computing equipment integrated into a vehicle or kiosk, equipment that implements the functionality of two or more of these devices, or virtually any type of wireless device.

STA 106 may include a processor (processing element) that is configured to execute program instructions stored in memory. STA 106 may perform any of the method embodiments described herein by executing such stored instructions. Alternatively, or in addition, STA 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein.

Wireless communications system 108 may include one or more wireless access points (APs) such as AP 102. AP 102 may be a stand-alone AP or an enterprise AP and may include hardware that enables wireless communication with STAs 106 such as STA 106A and STA 106B. AP 102 may also be equipped to communicate with a network 100 (e.g., a WLAN, an enterprise network, and/or another communication network connected to the Internet, among various possibilities). Thus, AP 102 may facilitate communication among STAs 106 and/or between STAs 106 and network 100. AP 102 can be configured to provide communications over one or more wireless technologies, such as any of IEEE 802.11 a, b, g, n, ac, ad, ax, ay, be, bn, and/or other 802.11 versions, or a cellular protocol, such as 5G, LTE, 3G, 2G, or 6G, including in an unlicensed band (LAA).

Network 100 may include any desired number of network nodes, terminals, and/or end hosts that are communicatively coupled together using communications paths that include wired and/or wireless links. The wired links may include cables (e.g., ethernet cables, optical fibers or other optical cables that convey signals using light, telephone cables, radio-frequency cables such as coaxial cables or other transmission lines, etc.). The wireless links may include short range wireless communications links that operate over a range of inches, feet, or tens of feet, medium range wireless communications links that operate over a range of hundreds of feet, thousands of feet, miles, or tens of miles, and/or long range wireless communications links that operate over a range of hundreds or thousands of miles.

The nodes of network 100 may be organized into one or more relay networks, mesh networks, local area networks (LANs), wireless local area networks (WLANs), ring networks (e.g., optical rings), cloud networks, virtual/logical networks, the Internet (e.g., may be communicably coupled to each other over the Internet), combinations of these, and/or using any other desired network topologies. The network nodes, terminals, and/or end hosts of network 100 may include network switches, network routers, optical add-drop multiplexers, other multiplexers, repeaters, modems, portals, gateways, servers, network cards (line cards), wireless access points, wireless base stations, and/or any other desired network components. The network nodes in network 100 may include physical components such as electronic devices, servers, computers, network racks, line cards, user equipment, etc., and/or may include virtual components that are logically defined in software and that are distributed across (over) two or more underlying physical devices (e.g., in a cloud network configuration).

The communication area (or coverage area) of AP 102 (or AP 104) may be referred to as a basic service area (BSA) or cell. AP 102 (or AP 104) and STAs 106 may be configured to communicate over the transmission medium using any of various radio access technologies (RATs) or wireless communication technologies, such as a wireless local area network (WLAN) technology (e.g., Wi-Fi), LTE, LTE-Advanced (LTE-A), 5G NR, ultra-wideband (UWB), 4G, 3G, 2G, wireless personal area network (WPAN) technology (e.g., Bluetooth), etc. A given RAT may, for example, specify the physical methodology (e.g., Layer 1 or physical layer circuitry or processing) used in implementing a corresponding communications protocol (e.g., a WLAN protocol, a wireless personal area network (WPAN) protocol, a cellular telephone protocol such as a 3G protocol, a 4G (LTE) protocol, a 5G (NR) protocol, etc., a UWB protocol, a satellite communications protocol, a satellite navigation protocol, a device-to-device (D2D) protocol, etc.).

AP 102, AP 104, and other similar access points (not shown) operating according to one or more wireless communication technologies may thus be provided as a network, which may provide continuous or nearly continuous overlapping service to STAs 106A and 106B and similar devices over a geographic area (e.g., via one or more communication technologies). A STA may roam from one AP to another AP directly or may transition between APs and cellular network cells, for example.

Note that at least in some instances STA 106 may be capable of communicating using any of multiple wireless communication technologies. For example, STA 106 might be configured to communicate using one or more of Wi-Fi, LTE, LTE-A, 5G NR, Bluetooth, UWB, one or more satellite systems (e.g., a constellation of communications satellites that communicate with one or more ground stations), etc. Other combinations of wireless communication technologies (including more than two wireless communication technologies) are also possible. Likewise, in some instances STA 106 can be configured to communicate using only a single wireless communication technology.

As shown in FIG. 1, the exemplary wireless communication system 108 can also include an AP 104, which communicates over a transmission medium with the wireless device 106B. AP 104 also provides communicative connectivity to network 100. Thus, according to some embodiments, wireless devices may be able to connect to either or both of AP 102 (or a cellular base station (BS)) and AP 104 (or another access point or BS) to access the network 100. For example, a STA may roam from AP 102 to AP 104 based on one or more factors, such as coverage, interference, and capabilities. Note that it may also be possible for AP 104 to provide access to a different network (e.g., an enterprise Wi-Fi network, a home Wi-Fi network, etc.) than the network to which the AP 102 provides access.

In some implementations, STAs 106 (e.g., STAs 106A and 106B) may include handheld devices such as smart phones or tablets, wearable devices such as smart watches or smart glasses, and/or may include any of various types of devices with wireless communication capability. For example, one or more of the STAs 106A and/or 106B may be a wireless device intended for stationary or nomadic deployment such as an appliance, measurement device, control device, etc.

STA 106B may also be configured to communicate with STA 106A. For example, STA 106A and STA 106B may be capable of performing direct device-to-device (D2D) communication. In some embodiments, such direct communication between STAs may also or alternatively be referred to as peer-to-peer (P2P) communication. The direct communication may be supported by AP 102 (e.g., AP 102 may facilitate discovery, among various possible forms of assistance), or may be performed in a manner unsupported by the AP 102. Such P2P communication may be performed using 3GPP-based D2D communication techniques, Wi-Fi-based P2P communication techniques, UWB, Bluetooth (BT), and/or any of various other direct communication techniques, according to various embodiments.

STA 106 may include one or more devices or integrated circuits for facilitating wireless communication, potentially including a WLAN (e.g., Wi-Fi) modem, a cellular modem, and/or one or more other wireless modems. The wireless modem(s) may include one or more processors (processor elements) and various hardware components as described herein. STA 106 may perform any of (or any portion of) the method embodiments described herein by executing instructions on one or more programmable processors. Alternatively, or in addition, the one or more processors may be one or more programmable hardware elements such as an FPGA (field-programmable gate array), or other circuitry, that is configured to perform any of the method embodiments described herein, or any portion of any of the method embodiments described herein. The wireless modem(s) described herein may be used in a STA as defined herein, a wireless device as defined herein, or a communication device as defined herein. The wireless modem described herein may also be used in an AP, a base station, a pico cell, a femto cell, or other similar network side device.

STA 106 may include one or more antennas for communicating using one or more wireless communication protocols or radio access technologies. In some embodiments, STA 106 can be configured to communicate using a single shared radio. The shared radio may couple to a single antenna, or may couple to multiple antennas (e.g., for multiple-input-and-multiple-output (MIMO)) for performing wireless communications. Alternatively, STA 106 may include two or more radios, each of which may be configured to communicate via a respective wireless link. Other configurations are also possible.

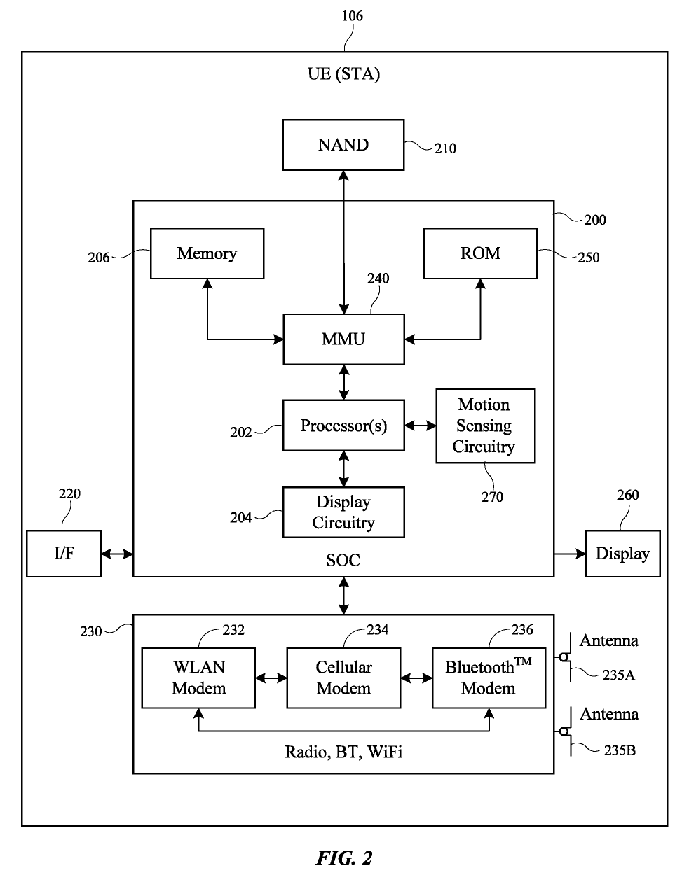

FIG. 2 is one possible block diagram of a STA device such as STA 106. STA 106 is sometimes also referred to herein as UE 106, UE device 106, device 106, electronic device 106, device 106, or client 106. STA 106 also may be referred to herein as non-AP STA 106, non-AP device 106, or non-AP client 106. As shown in FIG. 2, STA 106 may include wireless circuitry such as wireless communication circuitry 230, a subsystem such as system on chip (SOC) 200, a display such as display 260, and one or more interfaces such as connector interface (I/F) 220.

SOC 200 may include one or more portions configured for various purposes. For example, as shown in FIG. 2, SOC 200 may include one or more processors 202 and display circuitry 204. Processor(s) 202 may execute program instructions for STA 106. Display circuitry 204 may perform graphics processing and may provide display signals to display 260. Display 260 may be a touch-sensitive display, a force sensitive display, or a display without touch or force sensitivity. Display 260 may include one or more arrays of display pixels that emit light containing images, for example. Display 260 may be omitted from STA 106 if desired.

SOC 200 may also include sensor circuitry such as motion sensing circuitry 270. Motion sensing circuitry 270 may detect motion of the STA 106 using, for example, a gyroscope, accelerometer, inertial measurement unit (IMU), compass, a light-based motion sensor, a radar-based motion sensor, and/or any of various other motion sensing components. Processor(s) 202 may also be coupled to memory management unit (MMU) 240, which may be configured to receive addresses from processor(s) 202 and may translate those addresses to locations in memory or other storage circuitry (e.g., memory 206, read only memory (ROM) 250, flash (NAND) memory 210, etc.). MMU 240 may be configured to perform memory protection and page table translation or set up. In some embodiments, MMU 240 may be included as a portion of processor(s) 202.

SOC 200 may be coupled to various other circuits in STA 106. For example, SOC 200 may be coupled to various types of memory (e.g., flash memory 210), connector interface (I/F) 220 (e.g., for coupling to a computer system, dock, charging station, etc.), display 260, and wireless communication circuitry 230 (e.g., for performing wireless communications under LTE, LTE-A, 5G NR, Bluetooth, Wi-Fi, NFC, GPS, UWB, etc.).

STA 106 may include at least one antenna 235. If desired, STA 106 may include multiple antennas 235 such as at least a first antenna 235A and a second antenna 235B. STA 106 may use antennas 235 to perform wireless communication with access points, base stations, and/or other devices. For example, STA 106 may use antennas 235A and 235B to perform wireless communication with APs 102 and/or 104 of FIG. 1. As noted above, STA 106 may, in some embodiments, be configured to communicate wirelessly using multiple wireless communication standards or radio access technologies (RATs).

Wireless communication circuitry 230 may include one or more modems such as WLAN (e.g., Wi-Fi) modem 232, cellular modem 234, and/or Bluetooth modem 236. If desired, wireless communication circuitry 230 may include additional modems for handling other RATs or wireless communications technologies. STA 106 may use WLAN modem 232 (sometimes also referred to herein as Wi-Fi modem 232) to perform Wi-Fi or other WLAN communications (e.g., on an 802.11 network) with one or more external devices (e.g., AP 104 and/or 102 of FIG. 1). STA 106 may use Bluetooth modem 236 to perform Bluetooth communications or other WPAN communications with one or more external devices (e.g., another STA 106). STA 106 may use cellular modem 234 to perform cellular communications with one or more wireless base stations according to one or more cellular communication technologies (e.g., in accordance with one or more 3GPP specifications).

As described herein, STA 106 may include hardware and software components for implementing embodiments of this disclosure. For example, one or more components of the wireless communication circuitry 230 (e.g., Wi-Fi modem 232, cellular modem 234, BT modem 236) of the STA 106 may be configured to implement part or all of the methods described herein, for example, by one or more processors executing program instructions stored on a memory medium (e.g., a non-transitory computer-readable memory medium), a processor configured as a Field Programmable Gate Array (FPGA), and/or using dedicated hardware components, which may include an ASIC (Application Specific Integrated Circuit) if desired. STA 106 may include support structures such as a housing (sometimes also referred to as a case). The housing may include conductive and/or dielectric housing walls, layers, and/or other structures. Some or all of the components of STA 106 may be disposed within and/or on the housing.

If desired, STA 106 may include additional include input-output devices (not shown for the sake of clarity). The input-output devices may be used to allow data to be supplied to STA 106 and to allow data to be provided from STA 106 to external devices. The input-output devices may include user interface devices, data port devices (e.g., interface 220), touch sensors, displays (e.g., display 260), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to STA 106 using wired or wireless connections (e.g., some of the input-output devices may be peripherals that are coupled to a main processing unit or other portion of STA 106 via a wired or wireless link).

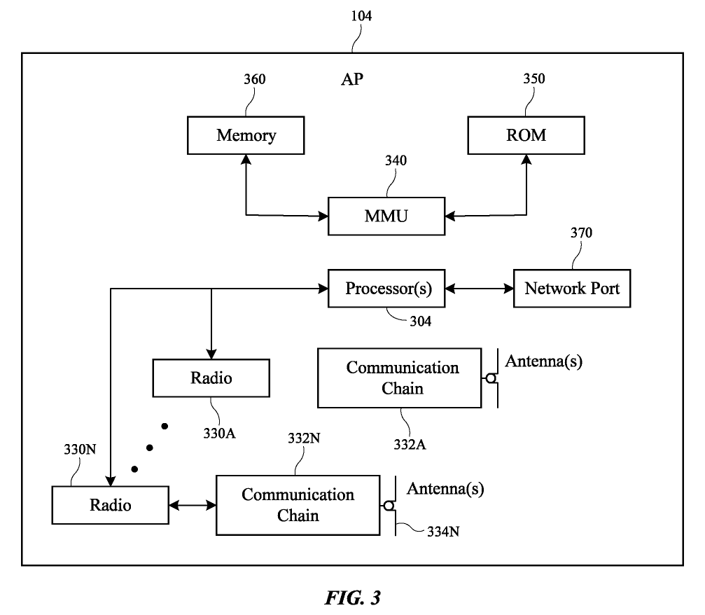

FIG. 3 is an example block diagram of an electronic device such as AP 104 (or equivalently AP 102 of FIG. 1). In some instances (e.g., in an 802.11 communication context), AP 104 may also be referred to as an AP STA. It is noted that the AP of FIG. 3 is just one example of a possible access point. As shown, AP 104 may include one or more processors 304, which may execute program instructions for AP 104. Processor(s) 304 may also be coupled to MMU 340, which may be configured to receive addresses from processor(s) 304 and to translate those addresses to locations in memory (e.g., memory 360 and ROM 350) or to other storage circuitry, circuits, or devices.

AP 104 may include at least one network port 370. Network port 370 may be configured to couple to a network and to provide multiple devices, such as STAs 106, with access to the network (e.g., network 100 of FIG. 1). Network port 370 (or an additional network port) may also, or alternatively, be configured to couple to a cellular network (e.g., a core network (CN) of a cellular service provider). The core network may provide mobility related services and/or other services to a plurality of UE devices (e.g., STAs 106). In some cases, network port 370 may couple to a telephone network via the core network, and/or the core network may provide a telephone network (e.g., among other UE devices serviced by the cellular service provider).

AP 104 may include one or more radios 330A-330N, each of which may be coupled to a respective communication chain 332 and at least one antenna 334, and possibly multiple antennas (e.g., a first radio 330A coupled to antenna 334A via communication chain 332A, an Nth radio 330N coupled to antenna 334N via communication chain 332N, etc.). Radios 330 may be configured to operate as wireless transceivers that communicate with STAs 106 via communication chains 332 and antennas 334. Antenna(s) 334A-N communicate with their respective radios 330A-N via communication chains 332A-N. Communication chains 332 may be receive chains, may be transmit chains, or may include both transmit and receive chains. Radios 330A-N may be configured to communicate in accordance with various wireless communication standards including, but not limited to, LTE, LTE-A, 5G NR, 6G, UWB, WLAN (Wi-Fi), WPAN (BT), UWB, satellite-based communications standards, etc. If desired, AP 104 may be configured to operate on multiple wireless links using the one or more radios 330A-N, where each radio is used to operate on a respective wireless link.

AP 104 may be configured to communicate wirelessly using one or multiple wireless communication standards. In some instances, AP 104 may include multiple radios, which may enable the network entity to communicate according to multiple wireless communication technologies. For example, as one possibility, AP 104 may include an LTE or 5G NR radio for performing communication according to LTE or 5G as well as a Wi-Fi radio for performing communication according to Wi-Fi. In such a case, AP 104 may be capable of operating as both a cellular base station and a Wi-Fi access point. As another possibility, AP 104 may include a multi-mode radio, which is capable of performing communications according to any of multiple wireless communication technologies (e.g., NR and Wi-Fi, NR and LTE, etc.). As still another possibility, AP 104 may be configured to act exclusively as a Wi-Fi access point (e.g., without cellular communication capability).

As described further herein, AP 104 may include hardware and software components for implementing or supporting implementation of features described herein. Processor(s) 304 of AP 104 may be configured to implement, or support implementation of, part or all of the methods described herein, e.g., by executing program instructions stored on a memory medium (e.g., a non-transitory computer-readable memory medium) to operate multiple wireless links using multiple respective radios. Alternatively, processor(s) 304 may be configured as a programmable hardware element, such as an FPGA (Field Programmable Gate Array) or ASIC (Application Specific Integrated Circuit), or a combination thereof. Alternatively (or in addition) the processor(s) 304 of AP 104, in conjunction with one or more of the other components 330, 332, 334, 340, 350, 360, 370, may be configured to implement, or support implementation of, part or all of the features described herein.

Radio(s) 330 on AP 104 may use antenna(s) 334 (FIG. 3) and wireless communication circuitry 230 on STA 106 may use antenna(s) 235 (FIG. 2) to transmit and/or receive radio-frequency signals within different frequency bands at radio frequencies (sometimes referred to herein as communications bands or simply as a “bands”). The frequency bands handled by AP 104 and STA 106 may include satellite communications bands (e.g., the C band, S band, L band, X band, W band, V band, K band, Kₐ band, Kᵤ band, etc.), wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6 band (e.g., from 5925-7125 MHz), a Wi-Fi® 7 band, and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, 6G bands, sub-THz cellular bands, etc.), other centimeter or millimeter wave frequency bands between 10-300 GHz, near-field communications (NFC) frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

Antenna(s) 334 (FIG. 3) and antenna(s) 235 (FIG. 2) may be formed using any desired antenna structures. For example, the antennas may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. If desired, one or more antennas may include antenna resonating elements formed from conductive portions of a device housing (e.g., peripheral conductive housing structures extending around a periphery of a display on STA 106). Filter circuitry, switching circuitry, impedance matching circuitry, and/or other antenna tuning components may be adjusted to adjust the frequency response and wireless performance of the antennas over time. If desired, multiple antennas may be implemented as a phased array antenna (e.g., where each antenna forms a radiator or antenna element of the phased array antenna, which is sometimes also referred to as a phased antenna array). In these scenarios, the phased array antenna may convey radio-frequency signals within a signal beam. The phases and/or magnitudes of each radiator in the phased array antenna may be adjusted so the radio-frequency signals for each radiator constructively and destructively interfere to steer or orient the signal beam in a particular pointing direction (e.g., a direction of peak signal gain). The signal beam may be adjusted or steered over time.

Wireless communication circuitry 230 may convey radio-frequency signals using antenna(s) 235 (FIG. 2). Radio(s) 330 may convey radio-frequency signals using antenna(s) 334 (FIG. 3). The term “convey radio-frequency signals” as used herein means the transmission and/or reception of the radio-frequency signals (e.g., for performing unidirectional and/or bidirectional wireless communications with external wireless communications equipment). The term “convey wireless data” as used herein means the transmission and/or reception of the wireless data (e.g., as carried by corresponding radio-frequency signals). Antennas may transmit radio-frequency signals by radiating the radio-frequency signals into free space (or to free space through intervening device structures such as a dielectric cover layer). Antennas may additionally, or alternatively, receive radio-frequency signals from free space (or through intervening devices structures such as a dielectric cover layer). The transmission and reception of radio-frequency signals by antennas each involve the excitation or resonance of antenna currents on an antenna resonating element in the antenna by the radio-frequency signals within the frequency band(s) of operation of the antenna.

Wireless communication circuitry 230 may be coupled to antenna(s) 235 (FIG. 2) over one or more radio-frequency transmission lines. Radio(s) 330 may be coupled to antenna(s) 334 (FIG. 3) over one or more radio-frequency transmission lines. Communication chain(s) 332 (FIG. 3) may be disposed on the radio-frequency transmission lines between antenna(s) 334 and radio(s) 330. The radio-frequency transmission lines may include coaxial cables, microstrip transmission lines, stripline transmission lines, edge-coupled microstrip transmission lines, edge-coupled stripline transmission lines, transmission lines formed from combinations of transmission lines of these types, etc. The radio-frequency transmission lines may be integrated into rigid and/or flexible printed circuit boards if desired. One or more of the radio-frequency lines may be shared between radios or modems if desired. Radio-frequency front end (RFFE) modules may be interposed on one or more of the radio-frequency transmission lines if desired (e.g., within communication chain(s) 332 of FIG. 3 or within wireless communication circuitry 230 of FIG. 2). The radio-frequency front end modules may include substrates, integrated circuits, chips, or packages that are separate from the radios or modems and may include filter circuitry, switching circuitry, amplifier circuitry, impedance matching circuitry, radio-frequency coupler circuitry, and/or any other desired radio-frequency circuitry for operating on the radio-frequency signals conveyed over the radio-frequency transmission lines.

Processor(s) 202 (FIG. 2) and processor(s) 304 (FIG. 3) may each include one or more processors such as microprocessors, microcontrollers, digital signal processors, host processors, baseband processing circuitry (e.g., one or more baseband processors or baseband processor integrated circuits), application specific integrated circuits (ASICs), FPGAs, central processing units (CPUs), graphics processing units (GPUs), etc. If desired, radio(s) 330 (FIG. 3) and/or wireless communication circuitry 230 may also include one or more processors. Baseband circuitry in STA 106 and/or AP 104 may, for example, access a communication protocol stack on corresponding storage circuitry (e.g., memory 206 of FIG. 2 or memory 360 of FIG. 3) to: perform user plane functions at a physical (PHY) layer, data link or media access control (MAC) layer, RLC layer, PDCP layer, SDAP layer, and/or PDU layer, and/or to perform control plane functions at the PHY layer, MAC layer, RLC layer, PDCP layer, RRC, layer, and/or non-access stratum layer.

AP 104 (or AP 102 of FIG. 1) may communicate with a STA 106 over a corresponding wireless communication link. Radio-frequency signals may be wirelessly conveyed between the radios and antennas on AP 104 and STA 106 to support the wireless communication link. The radio-frequency signals may include wireless data modulated onto one or more carriers of the radio-frequency signal (e.g., by a transmitter in radio 330 of AP 104 or a transmitter in a modem on wireless communication circuitry 230 of STA 106). The wireless data may be organized, modulated onto the radio-frequency signals, and demodulated from the radio-frequency signals (e.g., by a receiver in radio 330 of AP 104 or a receiver in a modem on wireless communication circuitry 230 of STA 106) according to a corresponding communications protocol or standard (e.g., an IEEE 802.11 protocol or standard). The radio-frequency signals may be conveyed (carried) across the transmission medium in one or more frequency bands associated with the communications protocol.

Implementations in which AP 104 and STA 106 communicate according to an IEEE 802.11 protocol or standard are described herein as an example. Under an 802.11 protocol, the wireless data is organized into a series or flow of frames (e.g., media access control (MAC) frames) carried by the radio-frequency signals. The frames, which are sometimes also referred to as packets, may include management frames, control frames, data frames, beacon frames, association frames, authentication frames, acknowledgement (ACK) frames, block ACK frames, trigger frames, trigger response frames, probe frames, association frames, reassociation frames, and/or other types of frames. Each frame may include a frame header, body (e.g., after the header), and trailer (e.g., after the body). The header may include, for example, source address (SA) information identifying the transmitter of the frame (sometimes also referred to herein as transmitter address (TA) information that identifies a corresponding TA), destination address information identifying the intended recipient of some or all of the frame (sometimes also referred to herein as recipient address (RA) information that identifies a corresponding RA), routing information, identifier information identifying one or more aspects of some or all of the frame (e.g., information identifying the type of frame), Association Identifier (AID) fields, control information, etc. The body may include, for example, a data payload (e.g., a payload of voice data, video data, web browsing data, application data, etc.). The trailer may include checking information that helps to verify the frame to the recipient. The checking information may include a frame check sequence (FCS) or cyclic redundancy check (CRC) field, as examples. If desired, the header, body, and/or trailer may include one or more message integrity check (MIC) fields (e.g., hash values or the output of other cryptographic functions that take as an input different portions of the frame and that are used to verify the integrity of the frame when received by a recipient). Fields of a frame or message are sometimes also referred to herein as elements of the frame or message.

Under a bidirectional communications link between AP 104 and STA 106, frames are conveyed both from AP 104 to STA 106 and from STA 106 to AP 104. STA 106 may transmit one or more ACK frames or block ACK frames to AP 104 to acknowledge the successful receipt of one or more frames transmitted by AP 104. AP 104 may transmit one or more ACK frames or block ACK frames to STA 106 to acknowledge the successful receipt of one or more frames transmitted by AP STA 106.

Radio-frequency signals are transmitted in a downlink (DL) direction from AP 104 to STA 106. Radio-frequency signals transmitted in the DL direction are sometimes also referred to herein as DL signals. The DL signals may carry DL data (e.g., DL frames transmitted by AP 104 to STA 106). Radio-frequency signals are transmitted in an uplink (UL) direction from STA 106 to AP 104. Radio-frequency signals transmitted in the UL direction are sometimes also referred to herein as UL signals. The UL signals may carry UL data (e.g., UL frames transmitted by STA 106 to AP 104).

A given AP 104 may support, maintain, and/or implement a Basic Service Sets (BSS) used in communicating with at least one STA 106 (e.g., according to the corresponding 802.11 protocol). If desired, a single physical AP 104 may concurrently support, maintain, and/or implement multiple BSS’s (e.g., may support wireless communications with different STAs associated with multiple BSS’s). The AP may, for example, utilize a first BSS to communicate with a first set of one or more STAs 106, a second BSS to communicate with a second set of one or more STAs 106, etc. When communications between AP 104 and a given STA 106 are initiated, the STA associates (registers) with AP 104 and is thereafter associated with a corresponding BSS of the AP (a procedure referred to as Association). A BSS may include and/or identify corresponding communications/operating parameters, device capabilities, security level information, and/or other information associated with the communications services provided by AP 104 to one or more STAs under that BSS.

Each BSS may be identified by a corresponding BSS identifier (BSSID). The BSSID may, for example, represent or correspond to a particular network address (e.g., MAC address) and/or wireless network name that is established, possessed, and/or maintained by the AP for wirelessly communicating using the corresponding BSS. If desired, a given AP 104 may concurrently or simultaneously support, implement and/or maintain multiple BSSIDs, in a communications scheme sometimes referred to herein as performing multiple BSSID (M-BSSID) operations or M-BSSID communications. When configured to perform M-BSSID communications, each BSSID maintained by AP 104 corresponds to a different network address (e.g., MAC address) and wireless network name maintained and operated by the AP.

Consider one example in which AP 104 is a Wi-Fi router or hot spot on a college campus and that is configured to perform M-BSSID communications. In this example, AP 104 may concurrently maintain a first BSSID named “STUDENT” for STAs 106 operated by students of the college campus and corresponding to a first MAC address of AP 104, a second BSSID named “STAFF” for STAs 106 operated by staff of the college campus and corresponding to a second MAC address of AP 104, a third BSSID named “GUEST” for STAs 106 operated by guests of the college campus, etc. Each BSSID may have different respective operating characteristics, security configurations, and/or settings. When a STA 106 enters the wireless coverage area of an AP, the user of the STA may interact with a user interface of the STA to select one of the BSSIDs of the AP to connect to. The AP may then associate the STA with or to that BSSID (e.g., if the STA meets one or more security conditions related to the BSSID such as being registered to a user who is granted access to that BSSID, providing a correct password to access that BSSID, etc.). Once associated with a given BSSID, the STA and the AP use that BSSID (e.g., the BSS identified by the BSSID) to convey wireless data. This example is illustrative and non-limiting.

In some deployments, different STAs 106 that attempt to access a channel of an AP 104 may have different corresponding communications capabilities for accessing the channel and/or performing communications with the AP. The capabilities may include distributed channel access capabilities associated with handling how multiple STAs attempt to concurrently access a channel of the AP. For example, a first set of one or more STAs may be able to attempt channel access using an Enhanced Distributed Channel Access (EDCA) procedure whereas a second set of one or more STAs may be able to attempt channel access using either the EDCA procedure or a Priority EDCA (P-EDCA) procedure (sometimes also referred to as a High Priority EDCA procedure). Unlike the second set of STAs, the first set of STAs is unable or incapable of performing a P-EDCA procedure. The STAs of the first set are therefore sometimes also referred to herein as an EDCA STAs, P-EDCA incapable STAs, or legacy STAs. On the other hand, the STAs of the second set are sometimes also referred to herein as P-EDCA STAs or P-EDCA capable STAs. The distributed channel access capabilities of a given STA may, for example, be determined by the version of the communications protocol (e.g., a Wi-Fi protocol) supported and/or implemented by the STA. For example, P-EDCA incapable STAs may operate using an earlier (legacy) version of the communications protocol (e.g., a Wi-Fi® 7 protocol (802.11be) or earlier) whereas P-EDCA capable STAs may operate using a newer (updated) version of the communications protocol (e.g., a Wi-Fi® 8 or 802.11bn protocol). In these situations, AP 104 supports both versions of the communication protocol (e.g., for communicating with both P-EDCA capable STAs and P-EDCA incapable STAs).

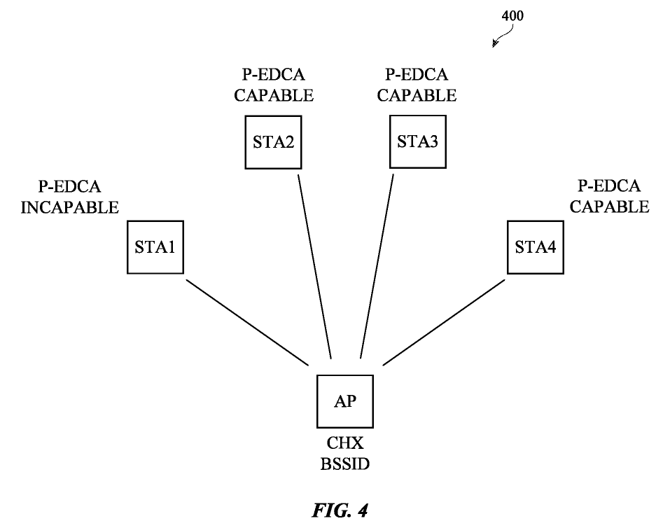

FIG. 4 shows one example deployment 400 of wireless communication system 108 (FIG. 1) that includes at least one AP 104, a first STA 106 (STA1), a second STA 106 (STA2), a third STA 106 (STA3), and a fourth STA 106 (STA4). In this example, STA1 and STA2 are P-EDCA incapable (legacy) STAs (e.g., operating using the Wi-Fi® 7 protocol or earlier) whereas STA3 and STA4 are P-EDCA capable STAs (e.g., operating using the Wi-Fi® 8 protocol or later). The AP supports both EDCA and P-EDCA procedures and has a corresponding BSSID. The example of FIG. 4 is for illustration purposes and is non-limiting. Deployment 400 may have other configurations, any desired number of APs, and any desired number of P-EDCA capable and/or P-EDCA incapable STAs.

STA1, STA2, STA3, and STA4 may associate with the AP (e.g., the BSSID of the AP) to perform wireless communications with the AP. These communications may involve uplink signal transmissions from the STAs to the AP during corresponding transmit opportunities (TXOPs). In some situations, the STAs may attempt to access the same channel CHX of the AP for performing TXOPs. To address situations where multiple STAs all have data (e.g., uplink data) to transmit to the AP over channel CHX at or around the same time, the communication protocol(s) supported by the STAs may define/specify one or more channel access procedures that the STAs are to perform prior to their respective TXOPs. The channel access procedure(s) may help to reduce the risk of uplink signal collisions between the STAs (e.g., increasing the likelihood that the uplink data is successfully received/decoded and acknowledged by the AP) while also introducing an element to fairness in providing channel access to the STAs (e.g., to help ensure that no STAs are unfairly provided with more access or faster access to channel CHX than other STAs).

In the deployment of FIG. 4, for example, STA1 and STA2 may perform an EDCA procedure to access channel CHX (e.g., because STA1 and STA2 are P-EDCA incapable). On the other hand, STA3 and STA4 may perform either the EDCA procedure or a P-EDCA procedure to access channel CHX. Unlike the EDCA procedure, the P-EDCA procedure may involve transmission, by a STA, of a defer frame (DF). The defer frame may serve to lock out other STAs from attempting to access the channel for a predetermined time period. This predetermined time period may allow the STA that transmitted the defer frame to attempt to access the channel without needing to compete with the other STAs, at least for the predetermined time period.

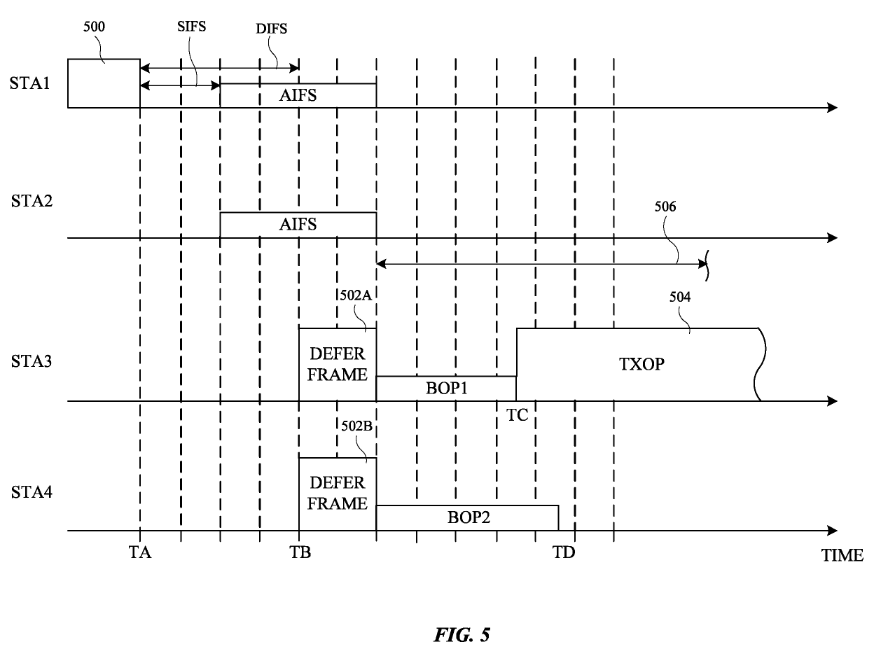

FIG. 5 is a timing diagram that illustrates how P-EDCA capable STAs such as STA3 and STA4 may perform a P-EDCA procedure to access channel CHX of the AP (e.g., in deployment 400 of FIG. 4 or a similar deployment). As shown in FIG. 5, STA1 may transmit an uplink packet 500 to the AP (e.g., during a corresponding TXOP of STA1). STA1 may finish transmission of packet 500 at time TA. A Short Interframe Spacing (SIFS) interval (period) may begin at the end of packet 500. The duration of the SIFS interval may be specified by the protocol and may be, for example, 16 microseconds. A Distributed Coordination Function (DCF) Interframe Spacing (DIFS) interval (period) may also begin at the end of packet 500. The DIFS interval is longer than the SIFS interval. The duration of the DIFS interval may be specified by the protocol and may be, for example, equal to the duration of the SIFS interval plus twice the slot time.

The other STAs of the AP (e.g., STA2, STA3, and STA4) may detect when transmission of packet 500 by STA1 ends and thus when the SIFS interval and the DIFS interval begin. P-EDCA incapable STAs such as STA1 and STA2 may begin corresponding Arbitration Interframe Spacing (AIFS) intervals after the SIFS interval has ended to start contending for channel access. In the example of FIG. 5, both P-EDCA capable STAs (STA3 and STA4) have uplink data queued for transmission to the AP at time TA or earlier. Both STA3 and STA4 may perform a P-EDCA procedure to attempt to access channel CHX of the AP for transmission of their queued uplink data.

To perform the P-EDCA procedure, STA3 and STA4 may first wait, without signal transmission, for the DIFS interval to elapse since the end of the last transmitted packet (e.g., the end of the packet 500 transmitted by STA1). When the DIFS interval has elapsed (e.g., at time TB, where TB – TA is equal to the duration of the DIFS interval) and the channel is still ideal/sufficient, each STA may transmit a defer frame 502. For example, STA3 may transmit defer frame 502A at time TB and STA4 may transmit defer frame 502B at time TB. Defer frames 502A and 502B may, for example, have the same frame structure, recipient (receiver) address (RA), and/or content (e.g., defer frames 502A and 502B may carry the exact same information). This may, for example, prevent concurrently-transmitted defer frames 502 from colliding with each other (e.g., preventing the defer frames from being properly received/decoded at another STA or the AP). Defer frames 502A and 502B may be structured as and/or may include Clear-to-Send (CTS) frames, as one example.

The transmission of a defer frame 502 may serve to lock out other STAs (e.g., P-EDCA incapable STAs and/or P-EDCA capable STAs that did not also transmit a defer frame at time TB) from attempting to access the channel during a predetermined time period 506 beginning at time TB (e.g., beginning at the start of the transmitted defer frame(s)). Predetermined time period 506 may be, for example, a protected service period (SP) (e.g., predetermined time period 506 is sometimes also referred to herein as protected SP 506 or simply as SP 506). The protected SP may have a duration that is set by the AP. If desired, the AP may announce the duration of protected SP in advance, such as using one more downlink or broadcast signal transmissions (e.g., in a beacon frame, TXOP response frame, association response frame, etc.). As one non-limiting example, predetermined time period 506 may have a duration of 97 microseconds.

When a STA such as STA1 or STA2 receives a defer frame 502, the STA may set or reset its Network Allocation Vector (NAV) to the duration of predetermined time period 506 (e.g., 97 microseconds), which is known to the STA from the defer frame duration field. The STA may then wait to contend for channel access until predetermined time period 506 has elapsed (e.g., may forego attempting to contend for channel access until after predetermined time period 506 has elapsed). These STAs may, for example, operate in a busy mode and/or in an extended interframe space (EIFS) mode during predetermined time period 506. STA2, STA3, and STA4 may operate in a busy mode during the transmission of packet 500 by STA1. STA1, STA2, STA3, and STA4 may operate in an idle mode during the SIFS interval beginning at time TA.

Only the STAs that transmitted a defer frame 502 at time TB will contend for channel access during predetermined time period 506 (e.g., STAs that did not transmit a defer frame are locked out from contending for channel access during predetermined time period 506). After transmitting a defer frame 502, the transmitting STA may then perform a transmit backoff procedure that determines when the STA transmits a Request-to-Send (RTS) frame to the AP (e.g., a request to send its queued uplink data). The transmit backoff procedure (sometimes also referred to herein as a transmit backoff or simply as a backoff (BO)) may involve the generation of a random number between a range of possible numbers. The random number that a STA generates determines how long the STA waits from the end of the defer frame before transmitting the RTS frame to the AP (e.g., the duration of a corresponding backoff period (BOP) utilized by the STA before attempting channel access).

For example, as shown in FIG. 5, STA3 may generate a first random number that corresponds to a first backoff period BOP1 and STA4 may generate a second random number that corresponds to a second backoff period BOP2. The random numbers may be true random numbers or pseudorandom numbers. STA3 may then transmit its RTS frame to the AP after backoff period BOP1 has elapsed since the end of defer frame 502A (e.g., at time TC). Similarly, STA4 may transmit its RTS frame to the AP after backoff period BOP2 has elapsed since the end of defer frame 502B (e.g., at time TD).

In this example, because backoff period BOP1 was shorter than backoff period BOP2 and the AP receives an RTS signal from STA3 (at time TC) before receiving an RTS signal from STA4 (at time TD), the AP will transmit a CTS signal in response to the RTS signal transmitted by STA3, allowing STA3 to perform/complete a corresponding TXOP 504 with the AP. STA3 may then transmit its uplink data (e.g., one or more physical protocol data units (PPDUs)) and the AP may transmit a corresponding acknowledgment (ACK) to the uplink data during TXOP 504. The TXOP 504 of STA3 may be defined as beginning at the beginning of the RTS frame transmitted by STA3. TXOP 504 effectively locks STA4 out of entering its own TXOP with the AP in channel CHX until the next contention opportunity. The random number generation of the transmit backoff procedure may introduce an element of fairness into which STAs are able to access channel CHX of the AP first. By locking other STAs out of contention using defer frames 502, P-EDCA capable STAs may greatly reduce the number of other STAs contending for access to channel CHX of the AP at the same time, increasing the likelihood of successfully entering a TXOP with the AP and reducing communication latency.

Unlike the P-EDCA procedure, an EDCA procedure (e.g., supported by P-EDCA incapable STAs such as STA1 and STA2) does not provide the STAs with the capability of transmitting a defer frame 502 to lock out other STAs from competing for channel access. The EDCA procedure may instead involve a similar transmit backoff procedure as described above in connection with backoff periods BOP1 and BOP2. However, because the P-EDCA incapable STAs are unable to lock out other STAs from contending for channel access, there is a higher risk that two STAs will select the same random number during the transmit backoff procedure, producing a collision between the RTS frames transmitted by those STAs. When this occurs, the STAs will perform another transmit backoff procedure using a random number selected from an even larger range. This type of exponentially increasing transmit power backoff can introduce substantial latency for both STAs to be able to access the channel for performing PPDU uplink transmission. The defer frames 502 of the P-EDCA procedure may help to mitigate these issues for P-EDCA capable STAs.

On the other hand, care should be taken to prevent P-EDCA capable STAs from unfairly utilizing or abusing defer frames to lock out other STAs from accessing the channel. To help balance overall performance for all STAs served by the AP, one or more conditions may be applied (e.g., in the protocol, by the STAs, and/or by the AP) before a P-EDCA capable STA performs a P-EDCA procedure and transmits its corresponding defer frame. In addition, the conditions may also help to ensure that the P-EDCA procedure is still able to provide priority channel access when needed by a P-EDCA capable STA, even as the number of P-EDCA capable STAs served by the AP increases over time (e.g., P-EDCA may fail without suitable conditions imposed on when a P-EDCA capable STA transmits defer frames). If desired, the AP may include one or more P-EDCA control or conditioning mechanisms in its BSS to help implement these mechanisms.

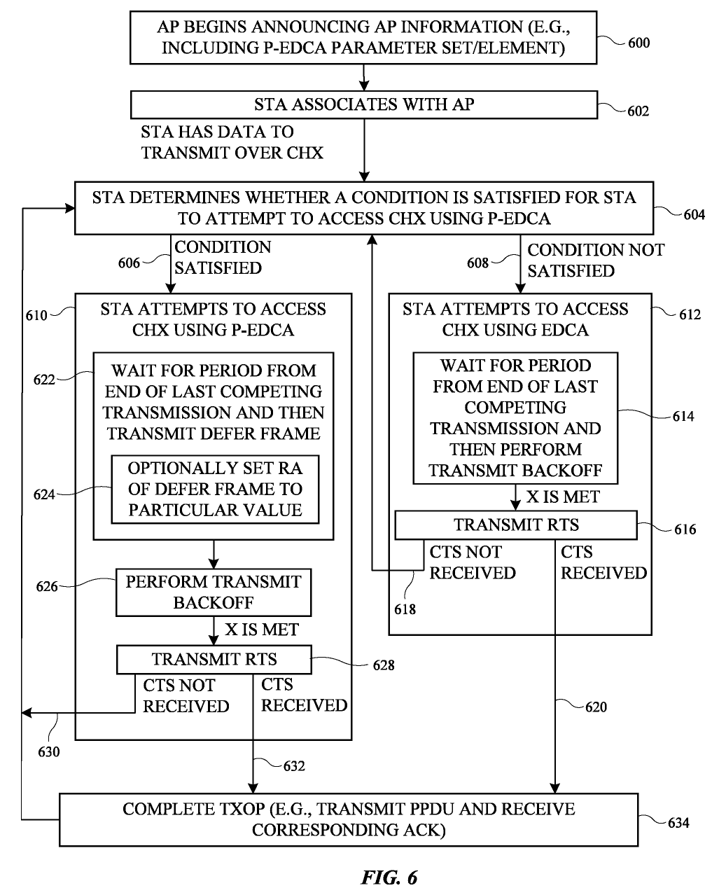

FIG. 6 is a flow chart of operations that may be performed by a P-EDCA capable STA 106 and a corresponding AP 104 to perform communications that apply one or more conditions on when the P-EDCA capable STA is able to perform a P-EDCA procedure (defer frame transmission).

At operation 600, AP 104 may announce AP information to one or more STAs in its coverage area. The AP information may include, for example, a set of P-EDCA parameters, sometimes also referred to herein as a P-EDCA parameter set. If desired, the AP may transmit the P-EDCA parameter set within a P-EDCA parameter element. The AP may include the P-EDCA parameter element within a header or another portion of a beacon frame, a TXOP response frame, an association response frame, and/or in any other desired frame structure (e.g., of a downlink and/or broadcast transmission). If desired, the AP may continue to transmit the P-EDCA parameter set before, after, and/or concurrent with one or more of the remaining operations of FIG. 6 (e.g., periodically).

At operation 602, STA 106 may associate with AP 104. This may involve, for example, the transmission of a probe request by the STA to the AP, transmission of a probe response by the AP to the STA, transmission of an authentication request by the STA to the AP, transmission of an authentication response by the AP to the STA, transmission of an association request by the STA to the AP, and/or transmission of a corresponding association response by the AP to the STA. If/when STA 106 has uplink data (e.g., one or more MAC service data units (MSDUs)) queued for transmission to AP 104 over a corresponding channel CHX (e.g., in a MAC uplink transmission queue of STA 106), STA 106 may need to perform an access procedure to access channel CHX of the AP, and processing may proceed to operation 604.

At operation 604, STA 106 may determine, detect, decide, or identify whether a condition is satisfied (e.g., has been met or fulfilled, is true, or passes) before proceeding to the remaining operations of FIG. 6. The condition may be a condition imposed by STA 106, AP 104, and/or the communication protocol for the STA. The condition may be a condition that must be satisfied for STA 106 to attempt to access channel CHX of AP 104 using a P-EDCA procedure instead of an EDCA procedure. The condition may be a single condition or may include a set of conditions that all need to be met for the condition to be considered satisfied. If/when the condition is satisfied (e.g., is met, is fulfilled, is true, or passes), processing may proceed from operation 604 to operation 610 via path 606 (e.g., the condition being satisfied may trigger processing to proceed to operation 610). If/when the condition is not satisfied (e.g., is unmet, is unfulfilled, is unsatisfied, is false, or fails), processing may proceed from operation 604 to operation 612 via path 608 (e.g., the condition being unsatisfied may trigger processing to proceed to operation 612).

At operation 612 (e.g., responsive to the condition at operation 604 not being met), STA 106 may attempt to access channel CHX of AP 104 using the EDCA procedure (e.g., without transmission of defer frames). This may include, for example, waiting for a time period (e.g., the SIFS interval plus an AIFSN from the end of the last competing transmission) and then performing a transmit backoff procedure (at operation 614). After a corresponding transmit backoff period has elapsed since the end of the SIFS interval, processing may proceed to operation 616. If desired, processing may proceed from operation 614 to operation 616 in response to a condition X being met. The condition X may be, for example, that the back off is zero and the channel is idle. If the condition X is unmet, processing may loop from operation 614 back to operation 604. At operation 616, STA 106 may transmit an RTS frame to the AP. This is illustrative and non-limiting and, if desired, STA 106 may transmit its data (e.g., a PPDU) directly instead of transmitting an RTS at operation 616. If/when the STA receives a CTS frame from the AP responsive to its transmitted RTS frame, this may be indicative of the STA successfully accessing channel CHX of the AP (e.g., continuing a corresponding TXOP for the STA that began at the beginning of the transmitted RTS frame) and processing may proceed to operation 634 via path 620. On the other hand, if/when the STA does not receive a CTS frame from the AP responsive to its transmitted RTS frame, this may be indicative of a collision or of the STA not successfully accessing channel CHX of the AP, and the STA may perform another transmit backoff procedure to attempt channel access again (e.g., processing may loop back to operation 604 via path 618).

At operation 610 (e.g., responsive to the condition at operation 604 being met), STA 106 may attempt to access channel CHX of AP 104 using the P-EDCA procedure. This may include, for example, waiting for a period (e.g., the DIFS interval or another interframe spacing interval from the end of the last competing transmission) and then transmitting a defer frame 502 (at operation 622). If desired, at optional operation 624, STA 106 may set the RA field of the transmitted defer frame to a broadcast address, the BSSID address, or a different reserved address (e.g., STA 106 may include, indicate, or identify one of these addresses in an RA field of the header of the defer frame).

In practice, the RA field of defer frames 502 should be set to a common address that is used by all P-EDCA capable STAs in the transmitted defer frames. This may, for example, prevent two defer frames that are transmitted at the same time (e.g., defer frames 502A and 502B of FIG. 5) from colliding with each other (e.g., because the content of all of the defer frames is identical), allowing the other STAs to correctly receive and decode the transmitted defer frame (e.g., to know to forego attempting to access the channel for predetermined time period 506 of FIG. 5). In some implementations, all P-EDCA capable STAs set the RA field of the transmitted defer frames 502 to the BSSID of the AP 104. This may allow the non-contending STAs to set their NAV (e.g., beginning predetermined time period 506) upon receiving and decoding the defer frame. However, setting the RA of defer frames 502 to the BSSID of AP 104 can cause the AP to act differently than the non-contending STAs. For example, AP 104 might not set its NAV upon receiving a defer frame addressed to its own BSSID. In addition, AP 104 may be confused if an RTS is sent before the defer frame in this situation (e.g., from a hidden node).

All P-EDCA capable STAs setting the RA field of defer frame 502 to a broadcast address may help to mitigate these issues. For example, this may allow AP 104 and non-contending STAs to defer transmission, while also allowing the AP to differentiate between regular CTS frames transmitted to the AP and CTS frames that are transmitted as defer frames 502. In addition, AP 104 may be able to differentiate between defer frames of its BSS and defer frames for overlapping basic service sets (OBSS) when the RA field is not set to the BSSID of the AP. This example is illustrative and non-limiting. In other implementations, STA 106 may set the RA field of its transmitted defer frame 502 to a predetermined defer frame RA value that is announced by the AP in advance (e.g., while processing operation 600, in a P-EDCA parameter element, etc.). In this way, all P-EDCA capable STAs of the AP may utilize the same RA field in their transmitted defer frames (e.g., an RA field that includes, indicates, or identifies the predetermined defer frame RA value announced by the AP, reserved beforehand, or the BSSID of the AP) while still offering the same benefits to the AP as setting the RA field equal to a broadcast address. If desired, the AP may use the BSSID address as the RA address of the defer frame to enable legacy devices to respond to the RTS sent during the protected contention period. The defer frame with RA address equal to the BSSID will result in setting the NAV for all of the STAs in or associated with the BSS but will not stop the STAs from sending a CTS frame as a response to the RTS. When sending a defer frame with the RA field equal to the broadcast address or another reserved address, the STA with P-EDCA enabled that receives the defer frame may set its NAV and not contend for channel access but may, if desired, respond to the received RTS with a CTS frame.

At operation 626, STA 106 may then perform a transmit backoff procedure. After a corresponding transmit backoff period BOP has elapsed since the end of the defer frame transmission, processing may proceed to operation 628. If desired, processing may proceed from operation 626 to operation 628 in response to a condition X being met. The condition X may be, for example, that the back off is zero and the channel is idle. If the condition X is unmet, processing may loop from operation 626 back to operation 604. At operation 628, STA 106 may transmit an RTS frame to the AP. This is illustrative and non-limiting and, if desired, STA 106 may transmit its data (e.g., a PPDU) directly instead of transmitting an RTS at operation 628. If/when the STA receives a CTS frame from the AP responsive to its transmitted RTS frame, this may be indicative of the STA successfully accessing channel CHX of the AP (e.g., continuing a corresponding TXOP for the STA that began at the beginning of the transmitted RTS frame) and processing may proceed to operation 634 via path 632. On the other hand, if/when the STA does not receive a CTS frame from the AP responsive to its transmitted RTS frame, this may be indicative of a collision or of the AP having not granted access to channel CHX for STA 106, and the STA may perform another transmit backoff procedure to attempt channel access again (e.g., processing may loop back to operation 626 via path 630).

At operation 634, STA 106 may continue and complete its TXOP (e.g., TXOP 504 of FIG. 5) with AP 104. The TXOP may end, for example, after STA 106 has finished transmitting its PPDU to AP 104 and after STA 106 has received a corresponding ACK to the PPDU from AP 104. Processing may loop back to operation 604 as STA 106 continues to need to access channel CHX for uplink transmission over time.

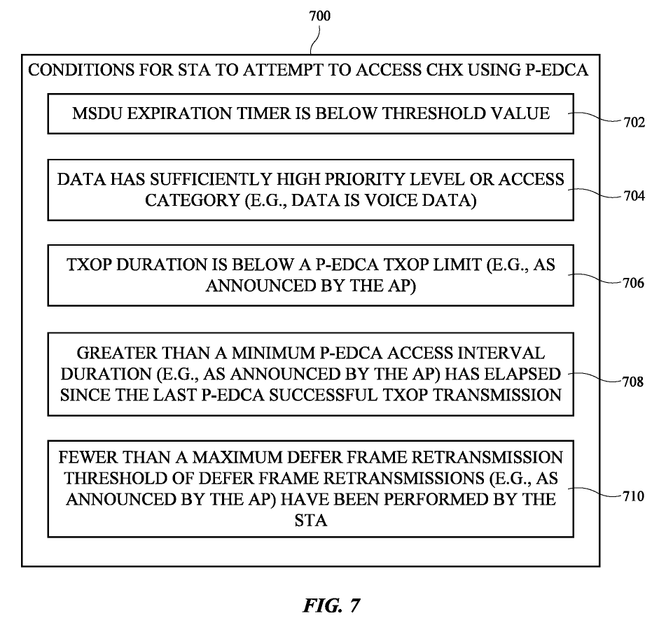

FIG. 7 shows a table 700 of illustrative conditions that may be imposed or applied at STA 106 for triggering transmission of a defer frame (e.g., for triggering a P-EDCA procedure to access channel CHX as opposed to an EDCA procedure to access channel CHX). STA 106 may, for example, check, verify, determine, decide, and/or detect whether one or more of the conditions in table 700 are satisfied while processing operation 604 of FIG. 6. If/when one or more of the conditions are satisfied, STA 106 may attempt channel access using the P-EDCA procedure (e.g., at operation 610 of FIG. 6). If/when one or more (e.g., all) of the conditions are unsatisfied, STA 106 may attempt channel access using the EDCA procedure (e.g., at operation 612 of FIG. 6).

As shown in FIG. 7, table 700 may include at least conditions 702, 704, 706, 708, and/or 710. This is illustrative and non-limiting. Any one of conditions 702-710 or any combination of conditions 702 may be detected to trigger the P-EDCA procedure. If desired, table 700 may include other conditions that trigger the P-EDCA procedure when satisfied.

Condition 702 may occur or be satisfied if/when a MAC service data unit (MSDU) expiration timer associated with the uplink data that STA 106 has queued for transmission (e.g., one or more MSDUs in its MAC transmission queue) is or falls below a threshold value (e.g., a threshold duration, time, or timer value). Put differently, condition 702 may occur when STA 106 has had uplink data (e.g., one or more MSDUs) queued for transmission, but where the uplink data has not yet been transmitted to AP 104 for longer than a threshold amount of time (e.g., when the queued uplink data is sufficiently aged or old). Conversely, condition 702 may be unsatisfied while the MSDU timer expiration for an MSDU in its transmission queue remains above the threshold value. STA 106 may determine whether condition 702 is met by, for example, comparing the MSDU expiration timer of an MSDU in its transmission queue to the threshold value. Condition 702 may, for example, serve to prioritize P-EDCA usage for STAs that have been waiting longer for transmission of their corresponding uplink data than STAs with fresher un-transmitted uplink data.

Additionally, or alternatively, condition 702 may be satisfied when a retransmission count of the uplink data exceeds a threshold value (e.g., when STA 106 has already attempted re-transmission of the uplink data a sufficient number of times). Conversely, condition 702 may be unsatisfied while the retransmission count remains below the threshold value. However, MSDU expiration may be a more reliable metric of low latency needs than retransmission count. Retransmission count may, for example, not reliably reflect delay (e.g., because MSDUs may be stuck in the queue due to channel condition with a retransmission count of zero, because MSDUs may have a high retransmission count but delay may still be very low due a hidden node issue). In addition, using retransmission count as a defer frame trigger can degrade P-EDCA performance (e.g., delaying use of the P-EDCA procedure by P-EDCA capable STAs) as well as EDCA performance by legacy STAs in many cases. Utilizing the MSDU expiration timer in condition 702 may help to ensure that P-EDCA is only used when needed, for example.

Condition 704 may occur or be satisfied if/when the uplink data that STA 106 has queued for transmission (e.g., one or more MSDUs in its MAC transmission queue) has a sufficiently high priority level (e.g., a priority level that exceeds a threshold priority level). Condition 704 may, for example, be satisfied when the uplink data has an access category (AC) of or associated with the threshold priority level or a higher priority level. STA 106 may determine whether condition 704 is satisfied by comparing the priority level or AC of the uplink data to a threshold priority level. As one example, condition 704 may be satisfied when the uplink data is voice data (e.g., data having a voice data access category AC_VO). STA 106 may, for example, determine that condition 704 is satisfied when the uplink data is voice data and may determine that condition 704 is unsatisfied when the uplink data is another type of data or of another AC.

Put differently, the STA may trigger the P-EDCA procedure if/when the P-EDCA procedure is being used to provide channel access to voice data. In other words, a STA accessing channel CHX using P-EDCA may limit access to P-EDCA to data with traffic identifiers (TIDs) belonging to the primary (highest priority) AC of P-EDCA such as a voice AC. If desired, STA 106 may utilize EDCA for channel access to all other types of uplink data (e.g., TIDs belonging to lower ACs such as non-voice ACs or other data having a lower priority level than voice data) or may still utilize P-EDCA for these other types of uplink data if another one of the conditions in FIG. 7 are met. This may help to minimize latency for high priority communications such as voice or video calls via AP 104.

Condition 706 may occur or be satisfied if/when the duration of a TXOP being performed by STA 106 is below a P-EDCA TXOP (time) limit. The P-EDCA TXOP limit may be configured/set and announced by AP 104 if desired (e.g., while processing operation 600 of FIG. 6, in a P-EDCA parameter element, etc.). This may, for example, allow the AP to control or limit P-EDCA for access to channel CHX. If desired, the same P-EDCA TXOP limit may be imposed for uplink data of the voice AC as for uplink data of non-voice ACs or a different (e.g., lower) P-EDCA TXOP limit may be imposed for uplink data of non-voice ACs than for the voice AC.

STA 106 may determine whether condition 706 has been satisfied by comparing the amount of time that has elapsed since the beginning of its transmitted RTS frame (e.g., as transmitted at operation 628 of FIG. 6) to the P-EDCA TXOP limit. The end of the transmitted defer frame may begin the transmit backoff procedure. If the channel is available after the transmit backoff procedure (e.g., the STA receives a CTS frame from the AP in response to the RTS frame transmitted by the STA at the end of the transmit backoff procedure), the beginning of the RTS frame forms the beginning of the TXOP of the STA. The time (duration) that has elapsed since the beginning of the TXOP (e.g., since time TC for STA3 in FIG. 5) may be compared to the P-EDCA TXOP limit. If/when the time since the beginning of the TXOP reaches or exceeds the P-EDCA TXOP limit, the STA may stop its current TXOP and any corresponding transmissions (e.g., the STA may follow the TXOP limit imposed by the AP during its TXOP). The STA may revert to performing EDCA for channel access or may reattempt the P-EDCA procedure later on. Put differently, when the STA gains access to the channel, the duration of its corresponding TXOP may be limited by the TXOP limit (e.g., the duration of the TXOP is less than or equal to the announced TXOP limit). In this way, the STA may only have access to the P-EDCA procedure for limited amount of time that is less than the P-EDCA TXOP limit imposed by the AP.

Condition 708 may occur or be satisfied if/when a greater amount of time than a minimum P-EDCA access interval duration has elapsed since the last successful P-EDCA TXOP by STA 106 (e.g., since the last defer frame transmission that resulted in successful channel access). For example, if STA 106 attempts to transmit a defer frame 502 that is separated in time from its last successful P-EDCA TXOP (e.g., from the last defer freame transmission resulting in successful channel access) by a duration that is less than the minimum P-EDCA access interval duration, the condition may be unsatisfied and STA 106 may delay or forego transmitting the defer frame. On the other hand, if STA 106 attempts to transmit a defer frame 502 that is separated in time from its last successful P-EDCA TXOP by a duration that exceeds the minimum P-EDCA access interval duration, the condition may be satisfied and STA 106 may proceed with transmitting the defer frames. This may, for example, serve to prevent a single STA from attempting to perform back-to-back defer frame transmissions too frequently (e.g., preventing the STA from unfairly locking out other STAs from competing for channel access too often). If desired, the minimum P-EDCA access interval and its corresponding duration may be configured/set and announced by AP 104 (e.g., while processing operation 600 of FIG. 6, in a P-EDCA parameter element, etc.). This may, for example, allow the AP to control or limit P-EDCA for access to channel CHX (e.g., in a manner that prevents P-EDCA capable STAs from performing defer frame transmission too frequently).

STA 106 may determine whether condition 708 has been satisfied by comparing the amount of time that has elapsed since its last defer frame transmission (e.g., as transmitted during a previous iteration of operation 610 of FIG. 6) to the minimum P-EDCA access interval duration. If/when the amount of time exceeds the minimum P-EDCA access interval duration (e.g., longer than the minimum P-EDCA access interval duration has elapsed since its last defer frame transmission), this may trigger the STA to proceed with transmitting another defer frame (e.g., for its current P-EDCA process). On the other hand, if/when the amount of time is less than the minimum P-EDCA access interval duration (e.g., shorter than the minimum P-EDCA access interval duration has elapsed since its last defer frame transmission), this may trigger the STA to forego transmitting another defer frame, to re-attempt the P-EDCA process, to instead perform the EDCA process (e.g., operation 612 of FIG. 6), etc. If desired, the minimum P-EDCA access interval duration may be tied to or set based on a latency budget for STA 106. The minimum P-EDCA access interval duration may effectively give an opportunity to other P-EDCA STAs to use P-EDCA and to transmit defer frames without collision with STA 106 (while also providing more opportunity for legacy STAs to perform EDCA).

Condition 710 may occur or be satisfied if/when STA 106 has retransmitted a defer frame 502 fewer than a maximum defer frame retransmission threshold number of times without channel access (e.g., when fewer than the maximum defer frame retransmission threshold of defer frame retransmissions has been performed without successful channel access and/or beginning a TXOP). For example, if STA 106 attempts to transmit a defer frame 502 too many times without obtaining channel access (e.g., a number of times greater than the maximum defer frame retransmission threshold), the condition may be unsatisfied and STA 106 may delay or forego continuing to retransmit the defer frame. On the other hand, if STA 106 has not yet attempted retransmission of a defer frame by a number of times less than the maximum defer frame retransmission threshold without successful channel access, STA 106 may proceed with retransmitting the defer frame. If desired, the STA may increment a defer frame transmit counter each time the defer frame is transmitted without gaining channel access (e.g., without starting a TXOP) and may compare the value of the counter to the maximum defer frame retransmission threshold. If/when channel access is achieved (e.g., beginning a TXOP), the counter may be reset to zero. This may, for example, serve to prevent a single STA from attempting to perform defer frame retransmissions too frequently (e.g., preventing the STA from unfairly locking out other STAs from competing for channel access too often). If desired, maximum defer frame retransmission threshold may be configured/set and announced by AP 104 (e.g., while processing operation 600 of FIG. 6, in a P-EDCA parameter element, etc.). This may, for example, allow the AP to control or limit P-EDCA for access to channel CHX (e.g., in a manner that prevents P-EDCA capable STAs from performing defer frame retransmission too frequently).

STA 106 may determine whether condition 710 has been satisfied by comparing the number of retransmissions that the STA has already performed (e.g., over a time period or in total) to the maximum defer frame retransmission threshold (e.g., by counting the number of defer frame transmissions that did not result in successful channel access and comparing the count to the maximum defer frame retransmission threshold). If/when the number of retransmissions is less than the maximum defer frame retransmission threshold, this may trigger the STA to proceed with retransmitting the defer frame. On the other hand, if/when the number of retransmissions exceeds the maximum defer frame retransmission threshold, this may trigger the STA to forego retransmitting the defer frame, to instead perform the EDCA process (e.g., operation 612 of FIG. 6), etc. The STA may, if desired, reset its defer frame retransmission count in response to successfully accessing the channel via EDCA.

In this way, a single STA 106 may be prevented from continuing to transmit defer frames if no channel access is achieved (e.g., if a CTS frame is not received from the AP responsive to the RTS frame transmitted by the STA after transmitting a defer frame), once the number of retransmissions of the defer frame exceeds the maximum defer frame retransmission threshold. Put differently, AP 104 may enforce a maximum number of consecutive defer frames transmitted by the STA when no channel access is achieved by that STA. If desired, the STA may resume defer frame transmission after a successful channel access.

When implementing any of conditions 702-710 of FIG. 7 (or any of the conditions that are checked while processing operation 604 of FIG. 6), STAs 106 may still respect or abide by multi-user (MU)-EDCA rules imposed by the AP, even if a corresponding P-EDCA trigger condition (e.g., any of conditions 702-710 of FIG. 6) is otherwise satisfied. For example, AP 104 may transmit a trigger frame to STA 106 to stop STA 106 from attempting to access channel CHX. In this situation, STA 106 may stop attempting to access channel CHX (e.g., may stop its P-EDCA procedure) even if one of conditions 702-710 is satisfied. This may, for example, help AP 104 to manage trigger-based traffic and quality of service (QoS) requirements across multiple users.

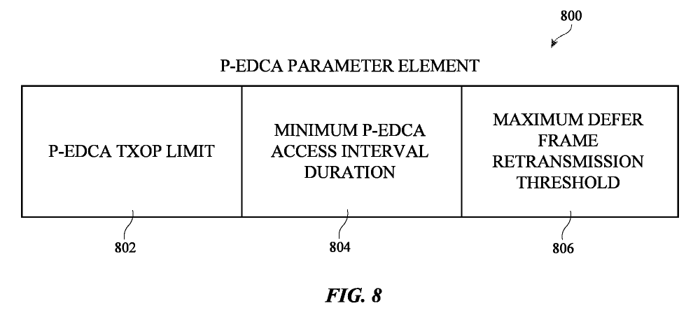

FIG. 8 is a diagram of an illustrative P-EDCA parameter element 800 that may be transmitted by AP 104 to STAs 106 (e.g., to announce one or more P-EDCA parameters that are used by P-EDCA capable STAs while performing a P-EDCA procedure). AP 104 may, for example, transmit P-EDCA parameter element 800 while processing operation 600 of FIG. 6. P-EDCA parameter element 800 may include, identify, or indicate a set or list of P-EDCA parameters. For example, as shown in FIG. 8, P-EDCA parameter element 800 may include a P-EDCA TXOP field 802, a minimum P-EDCA access interval duration field 804, and a maximum defer frame retransmission threshold field 806. Fields 802-806 may be arranged in other orders in P-EDCA parameter element 800. One or more of fields 802-806 may be omitted form P-EDCA parameter element 800. If desired, P-EDCA parameter element 800 may include one or more additional fields preceding, after, and/or between fields 802-806.

P-EDCA TXOP limit field 802 may signal, identify, or indicate a P-EDCA TXOP limit imposed by AP 104. P-EDCA capable STAs 106 may identify, detect, or determine, from P-EDCA TXOP limit field 802, the P-EDCA TXOP limit that is imposed while determining whether the STA satisfies condition 706 of FIG. 7 (e.g., while processing operation 604 of FIG. 6). P-EDCA TXOP limit field 802 is sometimes also referred to herein as P-EDCA TXOP duration limit field 802, P-EDCA TXOP field 802, TXOP duration limit field 802, or TXOP duration field 802.

Minimum P-EDCA access interval duration field 804 may signal, identify, or indicate a minimum P-EDCA access interval duration imposed by AP 104. P-EDCA capable STAs 106 may identify, detect, or determine, from minimum P-EDCA access interval duration field 804, the minimum P-EDCA access interval duration that is imposed while determining whether the STA satisfies condition 708 of FIG. 7 (e.g., while processing operation 604 of FIG. 6). Minimum P-EDCA access interval duration field 804 is sometimes also referred to herein as minimum P-EDCA access interval field 804.

Maximum defer frame retransmission threshold field 806 may signal, identify, or indicate a maximum defer frame retransmission threshold imposed by AP 104. P-EDCA capable STAs 106 may identify, detect, or determine, from maximum defer frame retransmission threshold field 806, the maximum defer frame retransmission threshold that is imposed while determining whether the STA satisfies condition 710 of FIG. 7 (e.g., while processing operation 604 of FIG. 6). Maximum defer frame retransmission threshold field 806 is sometimes also referred to herein as defer frame retransmission threshold field 806, retransmission threshold field 806, defer frame retransmission limit field 806, or defer frame retransmission field 806. AP 104 may transmit P-EDCA parameter element 800 within any desired frame structure. For example, AP 104 may transmit P-EDCA parameter element 800 within a beacon frame, a TXOP response frame, an association response frame, etc.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.” The term “when” also implies at least some concurrency (e.g., event A occurring “when” event B occurs means that at least some of event A is concurrent with at least some of event B).

STAs 106 and APs 102/104 (FIG. 1) may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The methods and operations described above in connection with FIGS. 1-9 may be performed by the components of a STA and/or AP using software, firmware, and/or hardware (e.g., dedicated circuitry or hardware). Software code for performing these operations may be stored on non-transitory computer readable storage media (e.g., tangible computer readable storage media) stored on one or more of the components of the STA and/or AP. The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of the STA and/or AP. The processing circuitry may include microprocessors, central processing units (CPUs), application-specific integrated circuits with processing circuitry, or other processing circuitry.

For one or more aspects, at least one of the components set forth in one or more of the preceding figures may be configured to perform one or more operations, techniques, processes, or methods as set forth in the example section below. For example, circuitry associated with an electronic device, authentication server, one or more processors, etc. as described above in connection with one or more of the preceding figures may be configured to operate in accordance with one or more of the examples set forth below in the example section. Examples

In the following sections, further exemplary aspects are provided.

Example 1 includes a method of operating a station (STA), the method comprising: determining, using one or more processors, whether a condition associated with accessing a channel of an access point (AP) has been satisfied; and transmitting, using a radio, a defer frame in the channel when the condition has been satisfied.

Example 2 includes the method of example 1 or some other example or combination of examples herein, further comprising: attempting, using the radio, to access the channel of the AP using an Enhanced Distributed Channel Access (EDCA) procedure when the condition has not been satisfied.

Example 3 includes the method any of example 1 or 2 or some other example or combination of examples herein, further comprising: transmitting, using the radio, a request-to-send frame after a backoff period has elapsed since an end of transmission of the defer frame.

Example 4 includes the method of any of examples 1-3 or some other example or combination of examples herein, wherein the defer frame comprises a clear-to-send (CTS) frame.

Example 5 includes the method of any of examples 1-4 or some other example or combination of examples herein, wherein the defer frame has a recipient address (RA) field that indicates a broadcast address or a basic service set identifier (BSSID) of the AP.

Example 6 includes the method of any of examples 1-5 or some other example or combination of examples herein, further comprising: receiving, using the radio, a frame from the AP, wherein transmitting the defer frame comprises setting a recipient address (RA) field of the defer frame to: a defer frame recipient address indicated by the frame received from the AP, or a predetermined defer frame recipient address.

Example 7 includes the method of any of examples 1-6 or some other example or combination of examples herein, wherein the condition comprises a Media Access Control Service Data Unit (MSDU) expiration timer associated with queued uplink data of the radio being less than a threshold.

Example 8 includes the method of any of examples 1-7 or some other example or combination of examples herein, wherein the condition comprises a priority level of queued uplink data of the radio being greater than a threshold priority level.

Example 9 includes the method of any of examples 1-8 or some other example or combination of examples herein, wherein the condition comprises queued uplink data of the radio having a voice access category (AC).

Example 10 includes the method of any of examples 1-9 or some other example or combination of examples herein, wherein the condition comprises a duration since a beginning of a current transmit opportunity (TXOP) of the radio being less than a threshold.

Example 11 includes the method of any of examples 1-10 or some other example or combination of examples herein, wherein the condition comprises a duration since a previous successful transmit opportunity (TXOP) by the radio being greater than a threshold.

Example 12 includes the method of any of examples 1-11 or some other example or combination of examples herein, wherein the condition comprises the radio having performed fewer than a threshold number of retransmissions of the defer frame.

Example 13 includes a method of operating a radio, the method comprising: associating with a basic service set identifier (BSSID) of an access point (AP); and attempting to access a channel of the AP, wherein attempting to access the channel of the AP comprises transmitting a defer frame that includes a recipient address (RA) field that indicates a recipient address other than the BSSID of the AP.

Example 14 includes the method of example 13 or some other example or combination of examples herein, wherein the recipient address indicated by the RA field comprises a broadcast address.

Example 15 includes the method of any of examples 13 or 14 or some other example or combination of examples herein, wherein the defer frame comprises a clear-to-send (CTS) frame.

Example 16 includes the method of any of examples 13-15 or some other example or combination of examples herein, further comprising: receiving, from the AP, a frame that identifies the recipient address indicated by the RA field of the defer frame.

Example 17 includes the method of any of examples 13-16 or some other example or combination of examples herein, wherein the frame comprises a beacon frame, a transmit opportunity (TXOP) response frame, or an association response frame.

Example 18 includes a method of operating an access point (AP), the method comprising: transmitting, to one or more stations (STAs), a Priority Enhanced Distributed Channel Access (P-EDCA) parameter element, wherein the P-EDCA parameter element indicates at least one P-EDCA parameter usable by the one or more STAs in determining when to transmit a defer frame associated with an attempt to access a channel of the AP.

Example 19 includes the method of example 18 or some other example or combination of examples herein, wherein the P-EDCA parameter element comprises a P-EDCA transmission opportunity (TXOP) limit, a minimum P-EDCA access interval duration, or a maximum defer frame retransmission threshold.

Example 20 includes the method of any of examples 18 or 19 or some other example or combination of examples herein, further comprising: receiving a request-to-send (RTS) frame from the one or more STAs in the channel; and transmitting a clear-to-send (CTS) frame to the one or more STAs responsive to the received RTS frame.

Example 21 may include an apparatus comprising means to perform one or more elements of a method described in or related to any of examples 1-20 or any combination thereof, or any other method or process described herein.

Example 22 may include one or more non-transitory computer-readable media comprising instructions to cause an electronic device, upon execution of the instructions by one or more processors of the electronic device, to perform one or more elements of a method described in or related to any of examples 1-20 or any combination thereof, or any other method or process described herein.

Example 23 may include an apparatus comprising logic, modules, or circuitry to perform one or more elements of a method described in or related to any of examples 1-20 or any combination thereof, or any other method or process described herein.

Example 24 may include a method, technique, or process as described in or related to any of examples 1-20 or any combination thereof, or portions or parts thereof.

Example 25 may include an apparatus comprising: one or more processors and one or more non-transitory computer-readable storage media comprising instructions that, when executed by the one or more processors, cause the one or more processors to perform the method, techniques, or process as described in or related to any of examples 1-20, or any combination thereof, or portions thereof.

Example 26 may include a signal as described in or related to any of examples 1-20, or any combination thereof, or portions or parts thereof.

Example 27 may include a datagram, information element, packet, frame, segment, PDU, or message as described in or related to any of examples 1-20, or any combination thereof, or portions or parts thereof, or otherwise described in the present disclosure.

Example 28 may include a signal encoded with data as described in or related to any of examples 1-20, or any combination thereof, or portions or parts thereof, or otherwise described in the present disclosure.

Example 29 may include a signal encoded with a datagram, IE, packet, frame, segment, PDU, or message as described in or related to any of examples 1-20, or any combination thereof, or portions or parts thereof, or otherwise described in the present disclosure.

Example 30 may include an electromagnetic signal carrying computer-readable instructions, wherein execution of the computer-readable instructions by one or more processors is to cause the one or more processors to perform the method, techniques, or process as described in or related to any of examples 1-20, or any combination thereof, or portions thereof.

Example 31 may include a computer program comprising instructions, wherein execution of the program by a processing element is to cause the processing element to carry out the method, techniques, or process as described in or related to any of examples 1-20, or any combination thereof, or portions thereof.

Example 32 may include a signal in a wireless network as shown and described herein.

Example 33 may include a method of communicating in a wireless network as shown and described herein.

Example 34 may include a system for providing wireless communication as shown and described herein.

Example 35 may include a device for providing wireless communication as shown and described herein.

Any of the above-described examples may be combined with any other example (or combination of examples), unless explicitly stated otherwise. The foregoing description of one or more implementations provides illustration and description but is not intended to be exhaustive or to limit the scope of aspects to the precise form disclosed.

What is claimed is:

1. A method of operating a station (STA), the method comprising:
determining, using one or more processors, whether a condition associated with accessing a channel of an access point (AP) has been satisfied; and
transmitting, using a radio, a defer frame in the channel when the condition has been satisfied.

2. The method of claim 1, further comprising:
attempting, using the radio, to access the channel of the AP using an Enhanced Distributed Channel Access (EDCA) procedure when the condition has not been satisfied.

3. The method of claim 2, further comprising:
transmitting, using the radio, a request-to-send frame after a backoff period has elapsed since an end of transmission of the defer frame.

4. The method of claim 3, wherein the defer frame comprises a clear-to-send (CTS) frame.

5. The method of claim 1, wherein the defer frame has a recipient address (RA) field that indicates a broadcast address or a basic service set identifier (BSSID) of the AP.

6. The method of claim 1, further comprising:
receiving, using the radio, a frame from the AP, wherein transmitting the defer frame comprises setting a recipient address (RA) field of the defer frame to:
a defer frame recipient address indicated by the frame received from the AP, or
a predetermined defer frame recipient address.

7. The method of claim 1, wherein the condition comprises a Media Access Control Service Data Unit (MSDU) expiration timer associated with queued uplink data of the radio being less than a threshold.

8. The method of claim 1, wherein the condition comprises a priority level of queued uplink data of the radio being greater than a threshold priority level.

9. The method of claim 1, wherein the condition comprises queued uplink data of the radio having a voice access category (AC).

10. The method of claim 1, wherein the condition comprises a duration since a beginning of a current transmit opportunity (TXOP) of the radio being less than a threshold.

11. The method of claim 1, wherein the condition comprises a duration, since a previous defer frame transmission by the radio that resulted in successful channel access, being greater than a threshold.

12. The method of claim 1, wherein the condition comprises the radio having performed fewer than a threshold number of retransmissions of the defer frame without successful channel access.

13. A method of operating a radio, the method comprising:
associating with a basic service set identifier (BSSID) of an access point (AP); and
attempting to access a channel of the AP, wherein attempting to access the channel of the AP comprises transmitting a defer frame that includes a recipient address (RA) field that indicates a recipient address other than the BSSID of the AP.

14. The method of claim 13, wherein the recipient address indicated by the RA field comprises a broadcast address.

15. The method of claim 14, wherein the defer frame comprises a clear-to-send (CTS) frame.

16. The method of claim 13, further comprising:
receiving, from the AP, a frame that identifies the recipient address indicated by the RA field of the defer frame.

17. The method of claim 16, wherein the frame comprises a beacon frame, a transmit opportunity (TXOP) response frame, or an association response frame.

18. A method of operating an access point (AP), the method comprising:
transmitting, to one or more stations (STAs), a Priority Enhanced Distributed Channel Access (P-EDCA) parameter element, wherein the P-EDCA parameter element indicates at least one P-EDCA parameter usable by the one or more STAs in determining when to transmit a defer frame associated with an attempt to access a channel of the AP.

19. The method of claim 18, wherein the P-EDCA parameter element comprises a P-EDCA transmission opportunity (TXOP) limit, a minimum P-EDCA access interval duration, or a maximum defer frame retransmission threshold.

20. The method of claim 19, further comprising:
receiving a request-to-send (RTS) frame from the one or more STAs in the channel; and
transmitting a clear-to-send (CTS) frame to the one or more STAs responsive to the received RTS frame.
